(19) United States
(12) Patent Application Publication
(10) Pub. No.: US 2002/0083172 A1
(43) Pub. Date: Jun. 27, 2002

(54) Systems, methods and computer program products for responding to client requests directed to networked embedded devices via proxy services

(76) Inventors: Gregory T. Knowles, Raleigh, NC (US); Brian T. Webb, Raleigh, NC (US); Bradley T. Marchesseault, Cary, NC (US); L. Joseph Bartolanzo, Durham, NC (US)

Correspondence Address: MYERS BIGEL SIBLEY & SAJOVEC, PO BOX 37428, RALEIGH, NC, 27627, US

(21) Appl. No.: 09/874,803

(22) Filed: Jun. 5, 2001

Related U.S. Application Data
(60) Provisional application No. 60/257,109, filed on Dec. 21, 2000.

(51) Int. Cl. G06F 15/173; G06F 15/16

(52) U.S. Cl. 709/225; 709/217

(57) ABSTRACT

Systems, methods, and computer program products that can allow users to communicate with networked embedded devices via a proxy service are provided. An embedded device searches for a proxy service and requests a discovered proxy service to respond to client requests to the embedded device on behalf of the embedded device. Servicing client requests on behalf of an embedded device may include obtaining a response to client requests from other sources and/or tailoring responses for display via a client device making the client request to the embedded device.

### RELATED APPLICATIONS

This application claims the benefit of U.S. Provisional Application No. 60/257,109, filed Dec. 21, 2000, the disclosure of which is incorporated herein by reference in its entirety as if set forth fully herein.

### FIELD OF THE INVENTION

The present invention relates generally to networks and, more particularly, to systems, methods and computer program products for accessing devices connected to networks.

### BACKGROUND OF THE INVENTION

Network connectivity is increasingly being added to everyday devices (e.g., vending machines, utility meters, factory equipment, security systems, home appliances, etc.) to permit user access to these devices directly over public and private networks without the need for computers and proprietary communication protocols. These types of devices are often referred to as “embedded devices” because they contain a small internal Web server or other communications service “embedded” within a microcontroller or microprocessor therewithin that can communicate with users.

An embedded device conventionally includes a microprocessor, non-volatile memory for storage of programs and other data associated with the embedded device, as well as an internal Web server or other communications service. Embedded devices conventionally use a salutation protocol to announce their presence and services to a network (and/or to other devices connected to a network). Interaction with an embedded device is conventionally accomplished by communicating with the internal Web server or other internal communications service.

Exemplary architectures used for embedded device salutation and connectivity include Universal Plug and Play (UPnP; www.upnp.org), Jini™ (www.jini.org), and Salutation (www.salutation.org). These architectures may be regarded as coordination frameworks that propose certain ways and means of embedded device interaction with the ultimate aim of simple, seamless and scaleable device inter-operability. UPnP, Jini™, and Salutation are well known to those skilled in the art of embedded devices.

When an embedded device is added to a network, a discovery protocol (e.g., UPnP, Jini™, or Salutation protocols) allows the embedded device to announce its presence on the network, along with information about itself and/or its services. Such an announcement may contain a URL that points to a description document located on a Web server within the embedded device. Conventionally, an embedded device description document includes vendor-specific information such as model name and number, serial number, and manufacturer of the embedded device.

An embedded device internal Web server conventionally allows HTML-based management of the embedded device by an end user using a client, such as a Web browser. A user can request a device management Web page from the internal Web server and manage the embedded device therefrom.

In order to reduce embedded device costs, Web servers included therewithin are conventionally simple and have reduced functionality. As a result, Web pages served by an embedded device Web server conventionally contain mostly informational content with limited functionality. For example, dynamic Web technologies such as servlets, ASP (Active Server Pages), JSP (Java Server Pages), Java applets, XML (Extensible Markup Language), and XSL (Extensible Stylesheet Language) may not be implemented feasibly via conventional embedded device Web servers. Moreover, embedded device Web servers may not be capable of presenting client-specific Web pages for devices such as phones, personal digital assistants (PDAs), and other handheld devices.

### SUMMARY OF THE INVENTION

In view of the above discussion, systems, methods, and computer program products that can allow users to communicate with networked embedded devices include selecting a proxy service for responding to client requests on behalf of an embedded device, redirecting client requests directed to the selected proxy service, and serving responses to client requests via the selected proxy service. In order to select a proxy service for responding to client requests on behalf of an embedded device, an embedded device discovers a proxy service that can serve as a proxy for the embedded device, and then requests the proxy service to serve as a proxy for the embedded device. An embedded device may also send information about the embedded device to a selected proxy service and/or may direct a proxy service to a location remote from the embedded device where information about the embedded device can be obtained.

According to embodiments of the present invention, a proxy service may be located on the same network to which an embedded device is connected and/or may be located on a different network that is in communication with the network to which an embedded device is connected. For example, an embedded device may be connected to a private network, such as a home network or intranet, and a proxy service may be connected to a public network such as the Internet. Moreover, embedded devices and proxy services may be connected to heterogeneous networks (e.g., networks having different types of devices connected thereto).

According to embodiments of the present invention, serving responses to redirected client requests via a selected proxy service may include obtaining responses to client requests from another source and/or tailoring responses for display via a client device making the client requests. A proxy service may serve responses in the form of Web pages that are configured to allow user management of embedded devices.

Embodiments of the present invention may allow smaller, less powerful network devices to leverage the processing power and storage capacity of more functional Web servers. Accordingly, inexpensive embedded devices can present Web pages having the functionality of Web pages served by full-function Web servers. Moreover, embodiments of the present invention may facilitate the use of dynamic technologies employed by conventional Web sites but not feasible via an embedded device Web server. Exemplary dynamic Web technologies that may be utilized according to embodiments of the present invention include, but are not limited to, servlets, ASP, JSP, Java applets, XML, and XSL.

### BRIEF DESCRIPTION OF THE DRAWINGS

FIG. 1 is a schematic diagram of a private network having various devices connected thereto including a gateway, a client that communicates with the embedded device, and a proxy service.

FIG. 2 is a schematic diagram of the private network of FIG. 1 in communication with a public network (i.e., the Internet) via a gateway, and wherein a client that communicates with the embedded device is connected to the public network.

FIG. 3 is a flowchart illustration of methods, apparatus (systems) and computer program products, according to embodiments of the invention, that can allow users to communicate with networked embedded devices.

### DETAILED DESCRIPTION OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout the description of the drawings.

As will be appreciated by one of skill in the art, the present invention may be embodied as methods, data processing systems, and/or computer program products. Accordingly, the present invention may take the form of an entirely hardware embodiment, an entirely software embodiment or an embodiment combining software and hardware aspects. Furthermore, the present invention may take the form of a computer program product on a computer-usable storage medium having computer-usable program code embodied in the medium. Any suitable computer readable medium may be utilized including, but not limited to, hard disks, CD-ROMs, optical storage devices, and magnetic storage devices.

Computer program code for carrying out operations of the present invention may be written in an object oriented programming language such as JAVA®, Smalltalk or C++. Computer program code for carrying out operations of the present invention may also be written in conventional procedural programming languages, such as “C”, or in various other programming languages. Software embodiments of the present invention do not depend on implementation with a particular programming language. In addition, portions of computer program code may execute entirely on one or more data processing systems.

The present invention is described below with reference to block diagram and/or flowchart illustrations of methods, apparatus (systems) and computer program products according to embodiments of the present invention. It is understood that each block of the block diagram and/or flowchart illustrations, and combinations of blocks in the block diagram and/or flowchart illustrations, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the block diagram and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block diagram and/or flowchart block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block diagram and/or flowchart block or blocks.

It should be noted that, in some alternative embodiments of the present invention, the functions noted in the blocks may occur out of the order noted in the figures. For example, two blocks shown in succession may in fact be executed substantially concurrently or the blocks may sometimes be executed in the reverse order, depending on the functionality involved. Furthermore, in certain embodiments of the present invention, such as object oriented programming embodiments, the sequential nature of the flowcharts may be replaced with an object model such that operations and/or functions may be performed in parallel or sequentially.

As is known to those of skill in the art, the Internet is a worldwide decentralized network of computers having the ability to communicate with each other. The World-Wide Web (Web) is comprised of server-hosting computers (Web servers) connected to the Internet that serve hypertext documents (referred to as Web pages). Web pages are accessible by client programs (e.g., Web browsers) utilizing the Hypertext Transfer Protocol (HTTP) via a Transmission Control Protocol/Internet Protocol (TCP/IP) connection between a client-hosting device and a server-hosting device. While HTTP and Web pages are the prevalent forms for the Web, the Web itself refers to a wide range of protocols and Web content formats.

A Web site is conventionally a related collection of files and/or programs that includes a beginning file called a “home” page. From the home page, a visitor can access other files and applications, including hypertext, graphics, sounds, movies, as well as links to other files and applications at other Web sites. A large Web site may utilize a number of servers, which may or may not be different and which may or may not be geographically-dispersed. For example, the Web site of the International Business Machines Corporation (www.ibm.com) consists of thousands of Web pages and files spread out over multiple Web servers in locations world-wide.

A Web server (also referred to as an HTTP server) is a computer program that utilizes HTTP to serve files that form Web pages to requesting Web clients. Exemplary Web servers are International Business Machines Corporation's family of Lotus Domino servers and the Apache server (available from www.apache.org). A Web client is a requesting program that also utilizes HTTP. A browser is an exemplary Web client for use in requesting Web pages and files from Web servers. A Web server waits for a Web client, such as a browser, to open a connection and to request a Web page. The Web server then sends a copy of the requested Web page to the Web client, closes the connection with the Web client, and waits for the next connection.

To ensure that browsers and Web servers can interoperate unambiguously, HTTP defines the format of requests (HTTP requests) sent from a browser to a Web server as well as the format of responses (HTTP responses) that a Web server returns to a browser. Exemplary browsers that can be utilized with the present invention include, but are not limited to, Netscape Navigator® (America Online, Inc., Dulles, Va.) and Internet Explorer™ (Microsoft Corporation, Redmond, Wash.). Browsers typically provide a graphical user interface for retrieving and viewing Web pages, applications, and other resources served by Web servers.

As is known to those skilled in this art, a Web page is conventionally formatted via a standard page description language such as HTML, which typically contains text and can reference graphics, sound, animation, and video data. HTML provides for basic document formatting and allows a Web content provider to specify anchors or hypertext links (typically manifested as highlighted text) to other servers. When a user selects a particular hypertext link, a browser running on the user's client device reads and interprets an address, called a Uniform Resource Locator (URL) associated with the link, connects the browser with a Web server at that address, and makes a request (e.g., an HTTP request) for the file identified in the link. The Web server then sends the requested file to the client device which the browser interprets and renders within a display screen.

An intranet is a private computer network contained within an enterprise or home, and conventionally includes one or more devices, such as computers, printers, security systems, heating and air conditioning systems, audio/video systems, and various embedded devices. Conventionally, an intranet is isolated from the Internet by hardware and software referred to as a “firewall.”

The term “private network”, as used herein, includes, but is not limited to, home networks, enterprise networks, and intranets. The term “public network”, as used herein, includes, but is not limited to, the Internet, wide area networks, cellular radiotelephone networks and/or satellite radiotelephone networks.

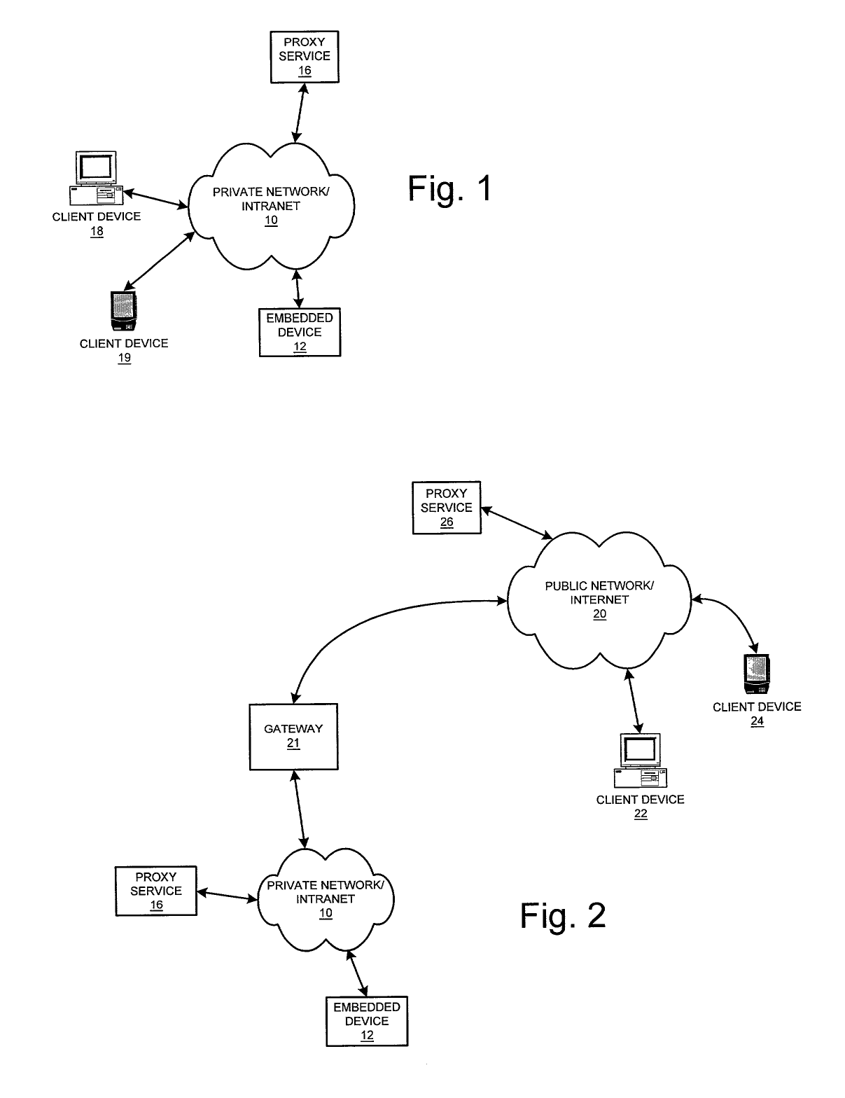

FIG. 1 is a schematic diagram of a private network 10 having a networked embedded device 12 according to embodiments of the present invention. It is understood that multiple embedded devices according to embodiments of the present invention can be connected to a network; however, for clarity, only one embedded device 12 is connected to the illustrated network 10. Embedded device 12 may be virtually any type of machine or device (e.g., a vending machine, utility meter, factory equipment, security system, home appliance, etc.).

Embedded device 12 may be connected to the private network 10 via various technologies including, but not limited to, Ethernet, wireless, phone-line networking, and power-line networking. The illustrated embedded device 12 may include an internal Web server that can allow a user via a client (e.g., a browser) to perform various configuration, trouble-shooting, and/or administrative functions with respect to the embedded device 12.

However, it is understood that embedded devices according to embodiments of the present invention need not have an internal Web server. For example, embedded devices utilizing the Jini™ protocol may be utilized. As understood by those skilled in the art, Jini™ devices have a well defined way of communicating that can be picked up by proxy services.

In the illustrated embodiment, the private network 10 also includes proxy service 16, and client devices 18, 19 connected thereto. The illustrated client device 18 is a conventional PC device and the illustrated client device 19 is a portable device, such as a PDA, handheld computer, and/or Web-enabled phone. However, various devices may serve as client devices according to embodiments of the present invention. Client devices 18, 19 may be connected to the private network 10 via wire connections or via wireless connections. The proxy service 16 is configured to act on behalf of the embedded device internal Web server. Proxy services are well understood by those of skill in the art and need not be described further herein.

According to embodiments of the present invention, the embedded device 12 is configured to “discover” a proxy service and to request a “discovered” proxy service to serve as a proxy for an internal Web server of the embedded device. Embedded devices according to embodiments of the present invention may be configured to discover more than one proxy service on a network as well as proxy services on other networks. In the illustrated embodiment of FIG. 1, the embedded device 12 is configured to “discover” the proxy service 16 connected to the private network 10.

Embedded devices according to embodiments of the present invention may be configured to provide information to a proxy service about itself and/or to direct a proxy service to another source of information about itself. For example, the illustrated embedded device 12 of FIG. 1 may be configured to provide information about itself directly to the proxy service 16. Moreover, the illustrated embedded device 12 may be configured to direct the proxy service 16 to another location (e.g., on the private network 10 and/or to another location on another network in communication with the private network 10) where information about the embedded device 12 can be obtained.

According to embodiments of the present invention illustrated in FIG. 1, when a user, via the client device 18, sends a client request to the embedded device 12, the request is redirected to the proxy service 16. The proxy service 16 may be configured to “masquerade” as the embedded device 12 and respond to the client request to the embedded device 12 as if the proxy service 16 was the embedded device 12. Alternatively, the client request to the embedded device 12 may be redirected to the proxy service 16 via a link within a Web page served by the embedded device 12.

The proxy service 16 is configured to respond to the client request and/or to obtain a response to the client request from another source (typically the embedded device itself via an agreed-to protocol). The proxy service 16 is preferably configured to present Web pages having the functionality of Web pages served by full function Web servers, and preferably facilitates the use of dynamic Web technologies including, but are not limited to, servlets, ASP, JSP, Java applets, XML, and XSL.

FIG. 2 is a schematic diagram of the private network 10 of FIG. 1 in communication with a public network 20 (i.e., the Internet) via a gateway 21. As is understood by those skilled in the art, a gateway is a network point that acts as an entrance to another network. For example, in the illustrated embodiment, the gateway 21 permits communications between devices on the public network 20 and devices on the private network 10.

Preferably, communications between a client on a public network and an embedded device on a private network, according to embodiments of the present invention, utilize a secure transmission scheme, such as Secure Sockets Layer (SSL). SSL is a commonly-used protocol for managing the security of a message transmission on the Internet, and is well known to those of skill in the art.

In the illustrated embodiment, several client devices 22, 24 and a proxy service 26 are connected to the public network 20. The illustrated client device 22 is a conventional PC device and the illustrated client device 24 is a portable device, such as a PDA, handheld computer, and/or Web-enabled phone. Various devices may serve as client devices. In addition, the client devices 22, 24 may be connected to the public network 20 via wire connections or via wireless connections.

According to embodiments of the present invention illustrated in FIG. 2, a user, via a client device 22, 24, sends a client request to the embedded device 12 on the private network 10 via the proxy service. The proxy service 16 is configured to respond to the client request and/or to obtain a response to the client request from another source. Another source may be the embedded device itself, but via a different protocol. The proxy service 16 is preferably configured to present Web pages having the functionality of Web pages served by full function Web servers, and preferably facilitates the use of dynamic Web technologies including, but are not limited to, servlets, ASP, JSP, Java applets, XML, and XSL.

According to embodiments of the present invention, the embedded device 12, upon discovering the existence of proxy service 26 on the public network, may announce its presence to the proxy service 26 and may request the proxy service 26 to respond to client requests directed to the embedded device 12.

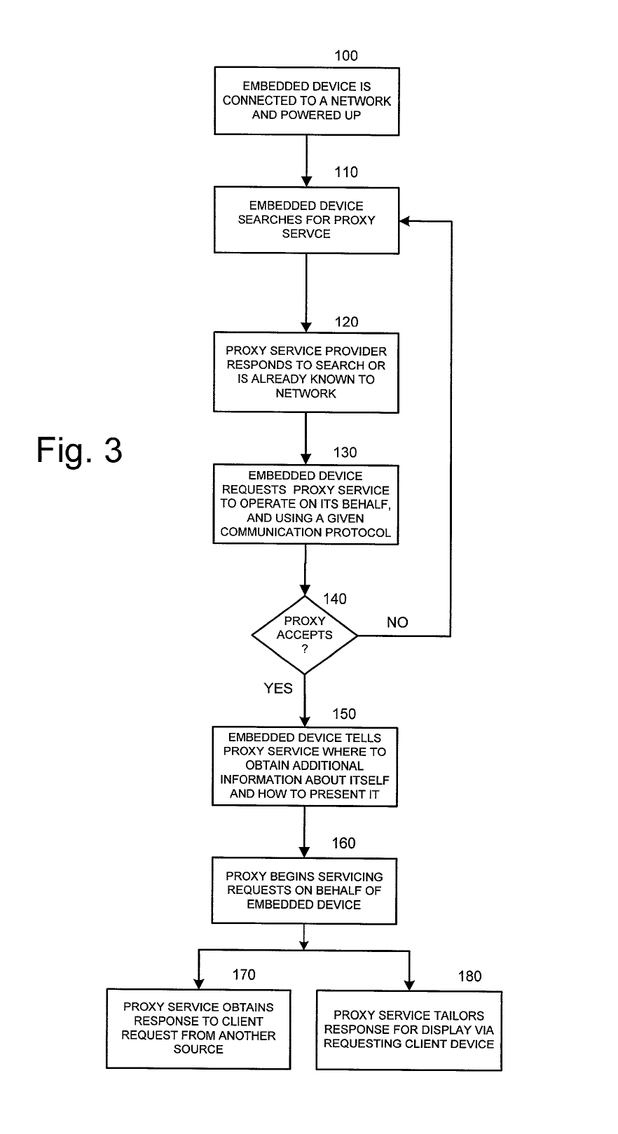

FIG. 3 is a flowchart illustration of methods, apparatus (systems) and computer program products, according to embodiments of the invention, that can allow users to communicate with networked embedded devices. An embedded device is initially connected to a network and powered up (Block 100). The embedded device then begins a search for proxy service (Block 110). A proxy service may be located on the same network to which an embedded device is connected or may be located on a different network that is in communication with the network to which the an embedded device is connected. For example, an embedded device may be connected to a private network, such as a home network or intranet, and a proxy service may be connected to a public network such as the Internet.

A proxy service provider may respond to the embedded device search (Block 120). The embedded device then requests that an identified (or “discovered”) proxy service operate on behalf of the embedded device and via a given communication protocol (Block 130). The proxy service and embedded device may negotiate communications protocols that will be used between the two. If the proxy service accepts this request (Block 140), the embedded device provides the proxy service with various information (Block 150). For example, the embedded device may provide the proxy service with information about the embedded device and/or may direct the proxy service to a location remote from the embedded device where information about the embedded device can be obtained. In addition, the embedded device may inform the proxy service how information is to be presented in response to client requests for information about the embedded device.

If the proxy service does not accept the request from the embedded device (Block 140), the embedded device initiates a new search for a proxy service (Block 110). A proxy service may reject an embedded device's request for various reasons. For example, a proxy service may be too busy, or may not support the communication/salutation protocol(s) of the embedded device.

Once a proxy service accepts the request of an embedded device to serve on behalf of the embedded device (Block 140) and has received various information from the embedded device (Block 150), the proxy service begins servicing client requests on behalf of the embedded device (Block 160).

Servicing client requests on behalf of the embedded device (Block 160) may include obtaining a response to client requests from another source (Block 170) and/or tailoring the response for display via a client device making the client request to the embedded device (Block 180). For example, wireless communications devices typically have displays that are small in size compared with desktop computer displays. As a result, content portions of a Web page, such as images and rendered HTML that may be otherwise displayable on a desktop computer display, may not be displayable on a wireless communications device display unless some modifications to the images and/or text (i.e., the content) are made. Furthermore, some wireless communications devices may not be capable of displaying certain image file types such as JPEG or GIF.

According to embodiments of the present invention, a proxy service may be configured to tailor content that is served to requesting clients. Image sizes may be transformed to a client device's capabilities. For example, large, high resolution, color images can be transformed into small, black and white images that can be displayed within small, low resolution displays. Text fonts and sizes may be changed to permit the display thereof. Moreover, data within frames and tables may be removed and/or reformatted into other configurations for proper display.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. An embedded device, comprising:
means for locating a proxy service that can respond on behalf of the embedded device to client requests directed to the embedded device; and means for requesting the located proxy service to serve as a proxy on behalf of the embedded device.

2. The embedded device according to claim 1, wherein means for requesting the located proxy service to serve as a proxy on behalf of the embedded device comprises means for negotiating a communications protocol.

3. The embedded device according to claim 1, further comprising means for providing information to the located proxy service about the embedded device.

4. The embedded device according to claim 1, further comprising means for providing information to the located proxy service about how to present information on behalf of the embedded device in response to client requests to the embedded device.

5. The embedded device according to claim 3, where in the means for providing information about the embedded device to the located proxy service comprises means for directing the proxy service to information about the embedded device maintained at a location remote from the embedded device.

6. The embedded device according to claim 1, further comprising means for announcing a presence of the embedded device to a network when the embedded device is connected to the network.

7. The embedded device according to claim 1, wherein the embedded device comprises a Web server, wherein the means for locating a proxy service comprises means for locating a proxy service that can serve as a proxy for the Web server, and wherein the means for requesting a proxy service to serve as a proxy on behalf of the embedded device comprises means for requesting the proxy service to serve as a proxy for the Web server.

8. A method of responding to client requests directed to an embedded device connected to a network, the method comprising the following performed by the embedded device:
locating a proxy service that can respond on behalf of the embedded device to client requests directed to the embedded device such that the proxy service can serve as a proxy on behalf of the embedded device.

9. The method according to claim 8, further comprising requesting the proxy service to serve as a proxy on behalf of the embedded device.

10. The method according to claim 9, wherein requesting the located proxy service to serve as a proxy on behalf of the embedded device comprises negotiating a communications protocol with the proxy service.

11. The method according to claim 8, further comprising providing information to the proxy service about the embedded device.

12. The method according to claim 8, further comprising providing information to the proxy service about how to present information on behalf of the embedded device in response to client requests to the embedded device.

13. The method according to claim 9, wherein providing information about the embedded device to the proxy service comprises directing the proxy service to information about the embedded device maintained at a location remote from the embedded device.

14. A method of responding to client requests directed to an embedded device connected to a network, the method comprising the following performed by a proxy service:
accepting a request from an embedded device to respond on behalf of the embedded device to client requests directed to the embedded device; and
serving responses to client requests directed to the embedded device.

15. The method according to claim 14, wherein serving responses to client requests directed to the embedded device comprises tailoring responses for display via client devices making client requests to the embedded device.

16. The method according to claim 14, wherein serving responses to client requests directed to the embedded device comprises obtaining responses to client requests from one or more other data sources.

17. The method according to claim 14, wherein serving responses to client requests directed to the embedded device comprises serving Web pages.

18. The method according to claim 17, wherein a Web page served by the proxy service is configured to allow users to manage the embedded device.

19. A system for responding to client requests directed to an embedded device connected to a network, comprising means for locating a proxy service that can respond on behalf of the embedded device to client requests directed to the embedded device such that the proxy service can serve as a proxy on behalf of the embedded device.

20. The system according to claim 19, further comprising means for requesting the proxy service to serve as a proxy on behalf of the embedded device.

21. The system according to claim 20, wherein means for requesting the located proxy service to serve as a proxy on behalf of the embedded device comprises means for negotiating a communications protocol with the proxy service.

22. The system according to claim 19, further comprising means for providing information to the proxy service about the embedded device.

23. The system according to claim 19, further comprising means for providing information to the proxy service about how to present information on behalf of the embedded device in response to client requests to the embedded device.

24. The system according to claim 20, wherein means for providing information about the embedded device to the proxy service comprises means for directing the proxy service to information about the embedded device maintained at a location remote from the embedded device.

25. A system for responding to client requests directed to an embedded device connected to a network, comprising:
means for accepting a request from an embedded device to respond on behalf of the embedded device to client requests directed to the embedded device; and
means for serving responses to client requests directed to the embedded device.

26. The system according to claim 25, wherein means for serving responses to client requests directed to the embedded device comprises means for tailoring responses for display via client devices making client requests to the embedded device.

27. The system according to claim 25, wherein means for serving responses to client requests directed to the embedded device comprises means for obtaining responses to client requests from one or more other data sources.

28. The system according to claim 25, wherein means for serving responses to client requests directed to the embedded device comprises means for serving Web pages.

29. The system according to claim 28, wherein a Web page served by the proxy service is configured to allow users to manage the embedded device.

30. A computer readable medium containing instructions for controlling an embedded device connected to a network to perform a method, the method comprising locating a proxy service that can respond on behalf of the embedded device to client requests directed to the embedded device such that the proxy service can serve as a proxy on behalf of the embedded device.

31. The computer readable medium according to claim 30, wherein the method further comprises requesting the proxy service to serve as a proxy on behalf of the embedded device.

32. The computer readable medium according to claim 31, wherein requesting the located proxy service to serve as a proxy on behalf of the embedded device comprises negotiating a communications protocol with the proxy service.

33. The computer readable medium according to claim 30, wherein the method further comprises providing information to the proxy service about the embedded device.

34. The computer readable medium according to claim 30, wherein the method further comprises providing information to the proxy service about how to present information on behalf of the embedded device in response to client requests to the embedded device.

35. The computer readable medium according to claim 31, wherein providing information about the embedded device to the proxy service comprises directing the proxy service to information about the embedded device maintained at a location remote from the embedded device.

36. A computer readable medium containing instructions for controlling a proxy service connected to a network to perform a method, the method comprising:
accepting a request from an embedded device to respond on behalf of the embedded device to client requests directed to the embedded device; and
serving responses to client requests directed to the embedded device.

37. The computer readable medium according to claim 36, wherein serving responses to client requests directed to the embedded device comprises tailoring responses for display via client devices making client requests to the embedded device.

38. The computer readable medium according to claim 36, wherein serving responses to client requests directed to the embedded device comprises obtaining responses to client requests from one or more other data sources.

39. The computer readable medium according to claim 36, wherein serving responses to client requests directed to the embedded device comprises serving Web pages.

40. The computer readable medium according to claim 39, wherein a Web page served by the proxy service is configured to allow users to manage the embedded device.
